(19) United States
(12) Patent Application Publication
(10) Pub. No.: US 2026/0280157 A1
(43) Pub. Date: Sep. 17, 2026

(54) CONDUCTOR CONNECTION TERMINAL AND ELECTRICAL PLUG CONNECTOR

(71) Applicant: WAGO Verwaltungsgesellschaft mbH, Minden (DE)

(72) Inventors: Paul-Sebastian SCHETTLER, Sondershausen (DE); Rudolf MASTEL, Minden (DE)

(73) Assignee: WAGO Verwaltungsgesellschaft mbH, Minden (DE)

(21) Appl. No.: 19/565,269

(22) Filed: Mar. 12, 2026

(30) Foreign Application Priority Data
Mar. 13, 2025 (DE) 20 2025 101 347.9

(51) Int. Cl. H01R 4/48

(52) U.S. Cl. CPC H01R 4/4828; H01R 4/48185

(57) ABSTRACT

A conductor connection terminal having an insulation material housing and at least one spring-loaded clamping connection, arranged in the insulation material housing, for connecting an electrical conductor via elastic force. The spring-loaded clamping connection includes at least one busbar and at least one clamping spring having a clamping leg for clamping the electrical conductor to at least one contact section of the busbar. The insulation material housing has at least one conductor insertion opening through which an electrical conductor is guidable in a conductor insertion direction to a clamping point formed by the clamping leg and the contact section of the busbar. The conductor connection terminal has a manual actuator in the form of a displaceable push button or actuating slider via which by manual actuation the clamping leg may be moved into an open position via a displacement movement of the actuator relative to the insulation material housing.

This nonprovisional application claims priority under 35 U.S.C. § 119(a) to German Patent Application No. 20 2025 101 347.9, which was filed in Germany on Mar. 13, 2025, and which is herein incorporated by reference.

### BACKGROUND OF THE INVENTION

### Field of the Invention

The invention relates to a conductor connection terminal having an insulation material housing and at least one spring-loaded clamping connection, arranged in the insulation material housing, for connecting an electrical conductor by means of elastic force, wherein the spring-loaded clamping connection includes at least one busbar, and at least one clamping spring having a clamping leg for clamping the electrical conductor to at least one contact section of the busbar, wherein the insulation material housing has at least one conductor insertion opening through which an electrical conductor is guidable in a conductor insertion direction to a clamping point formed by the clamping leg and the contact section of the busbar, wherein the conductor connection terminal has a manual actuating element in the form of a displaceable push button or actuating slider via which by manual actuation the clamping leg may be moved into an open position by means of a displacement movement of the actuating element relative to the insulation material housing, wherein upon reaching the open position, the actuating element is latchable to at least one component of the conductor connection terminal, wherein in the latched position of the actuating element the clamping leg is held in the open position by the actuating element. The latching of the actuating element in the open position allows the clamping leg to be held in the open position even when the actuating element is no longer being actuated. The invention further relates to an electrical plug connector, in particular a circular plug connector, having at least one such conductor connection terminal.

### Description of the Background Art

A conductor connection terminal having a push actuator is known from, for example, EP 3 465 828 B1, which corresponds to US 2019/0319374.

### SUMMARY OF THE INVENTION

It is therefore an object of the present invention to provide a further improved conductor connection terminal.

For a conductor connection terminal of the type mentioned at the outset, this object is achieved in that the actuating element, at least during the displacement movement, is guided by means of at least one guide pin that is guided in a guide groove that extends at least predominantly in the displacement direction of the actuating element. Precise, low-play guiding of the displaceable actuating element can be achieved by use of such a guide pin that is guided in a guide groove. The actuating element is easy to actuate manually, and does not easily catch or tilt during the displacement movement. For example, a type of sliding guide for the actuating element may be achieved by means of the least one guide pin and the guide groove. Depending on the example, the at least one guide pin may be arranged at the actuating element, and the guide groove in which the guide pin is guided may be arranged at some other part of the conductor connection terminal, for example at the insulation material housing or the busbar. There may also be a reverse association; i.e., the guide groove may be part of the actuating element. In this case, the at least one guide pin may be arranged at the insulation material housing or at the busbar, for example.

In particular, at least two guide pins may be present which are guided in the same guide groove. This results in even better, more stable longitudinal guiding of the actuating element during the displacement movement. In addition, an additional swivel movement of the actuating element may be easily and advantageously achieved, as explained in greater detail below. The at least two guide pins that are guided in the same guide groove may be spaced apart behind one another in the displacement direction of the actuating element, which on the one hand ensures stable longitudinal guiding of the actuating element during the displacement movement. On the other hand, desired swiveling of the actuating element upon approaching the open position may be assisted, in particular in combination with at least one protrusion and/or a curved section of the guide groove in the area of the open position. The distance between the at least two guide pins which are guided in the same guide groove may be, for example, at least 10% of the length of the guide groove in the displacement direction.

The clamping leg together with the contact section of the busbar may form a clamping point for connecting an electrical conductor between the clamping leg and the contact section. An opened clamping point (open position) is characterized in that at least the clamping edge of the clamping leg is swiveled away from the contact section of the busbar, i.e., is arranged at a greater distance from the contact section than it is in a clamping position. The clamping leg may be swiveled, for example, between the open position, in which the electrical conductor is freely movable between the clamping leg and the contact section, and the clamping position, in which the clamping leg clamps the electrical conductor to the contact section.

According to an example of the invention, it can be provided that at least the predominant portion of the guide groove extends in a straight line, in particular in parallel to the conductor insertion direction. For example, in this linear portion of the guide groove, the at least one guide pin may be guided from an initial position of the actuating element, in which the clamping leg is not yet actuated or is only slightly actuated by the actuating element, to just before the position in which the clamping leg reaches the open position.

Upon reaching the open position, the actuating element can be latchable to at least one component of the conductor connection terminal by means of a swivel movement. In this way, the actuating element, which is designed predominantly for a displacement movement, may be expanded to a functionality similar to a rocker or a rocker pusher. The swivel movement in the area of the open position allows additional functionalities of the actuating element, for example latching as well as a simple type of unlatching, as explained in greater detail below.

The guide groove in the area of the open position can have at least one protrusion and/or a curved section by means of which the actuating element is guided during the swivel movement. In this way, the guide contour allows targeted swiveling of the actuating element in the area of the open position. If the mentioned protrusion is present, the guide groove, which otherwise tightly encloses the guide pin, may be slightly widened so that the guide pin in this area is no longer precisely guided, and instead may be moved into the protrusion by means of the swivel movement. If the guide contour has the mentioned curved section, the guide pin may continue to be narrowly guided through the guide groove, also in the curved section, and is thus assisted in the swivel movement.

In the example in which at least two guide pins which are guided in the same guide groove are present, the swivel movement of the actuating element may be implemented in particular by a first guide pin entering the curved section of the guide groove or the protrusion, while a second guide pin remains in the linear section of the guide groove.

The swivel movement of the actuating element in the open position may be partially, predominantly, or completely carried out by a reaction force of the clamping spring that acts by the clamping leg on the actuating element. In this way the swivel movement of the actuating element may be at least assisted by the clamping leg, which is meaningful, for example, when the guide contour has only the protrusion but not the curved section.

The latching of the actuating element in the open position may be achieved, for example, by the actuating element carrying out the swivel movement and thus being latched. The reaction force of the clamping spring exerts a torque on the actuating element, as a result of which the first guide pin is held in the curved section or the protrusion.

The actuating element can have a first detent element via which the actuating element in the open position is latchable to a second detent element of another component of the conductor connection terminal, in particular to the busbar or to the insulation material housing. In this way, it is possible to achieve either alternative latching of the actuating element in the open position, i.e., as an alternative to the above-mentioned tensioning, or additional latching which is present in addition to the tensioning.

The conductor connection terminal can have a release element with a release section, via which the latching of the actuating element in the open position is releasable and the clamping leg is automatically movable from the open position in the direction of the clamping position when the release section is acted on with a release force by the inserted electrical conductor. The conductor connection terminal may thus be advantageously refined for a functionality for an automatic conductor connection. The inserted electrical conductor may bring about an automatic release of the latching of the actuating element due to the release force exerted on the release section, as a result of which the actuating element may be automatically moved back in the direction of the unactuated position, and the clamping leg may be automatically moved back into the clamping position, due to the restoring force of the clamping leg. In the clamping position the electrical conductor is clamped by the clamping leg to the contact section of the busbar.

The release section may in particular be configured to exert a torque on the actuating element when the release section is acted on with the release force by the electrical conductor, via which the actuating element may be swiveled back from the swiveled position into the open position.

The release element can be arranged at the actuating element, at the busbar, or at the clamping spring, and in particular is formed in one piece with the actuating element, with the busbar, or with the clamping spring. This simplifies the design of the conductor connection terminal and installation of the individual parts. The arrangement of the release element at the actuating element is particularly advantageous.

The release section can have at least one area, arranged obliquely with respect to the conductor insertion direction, via which the electrical conductor is deflected toward the contact section during the insertion operation. This has the advantage that by means of the electrical conductor, a torque may be transferred to the actuating element in a targeted manner, via which the actuating element may be released from its swiveled locking position, i.e., may be swiveled back. The latching is thus released, so that due to the restoring force of the clamping leg the actuating element may be moved once again in the direction of the unactuated position. For example, over its entire longitudinal extension or a portion of its longitudinal extension the release section may be a curved release section, for example with a constant curvature. It is advantageous when at least the area of the release section that is arranged obliquely with respect to the conductor insertion direction is inclined at an angle of less than 60 degrees or less than 45 degrees relative to the conductor insertion direction.

At least one elastically deflectable detent arm can be arranged at the actuating element or is formed in one piece with the actuating element, the detent arm having a first detent element for latching the actuating element in the open position. In this way, it is possible to achieve either alternative latching of the actuating element in the open position as an alternative to the above-mentioned tensioning, or additional latching which is present in addition to the tensioning

For example, the first detent element may be formed as a detent projection, and the second detent element may be formed as a detent recess or detent edge. There may also be a reverse association.

The detent arm can be deflectable by actuating the release section in order to release the latching of the actuating element in the open position. This allows simple release of the latching without having to swivel the entire actuating element or move it in some other way. The release element may advantageously be arranged directly at the detent arm, and in particular may be formed in one piece with the detent arm. This further simplifies the design of the conductor connection terminal and lowers the manufacturing costs. The entire detent arm may be formed, for example, in one piece with the actuating element, for example as a plastic injection-molded part.

A variant of the invention relates to a conductor connection terminal of the type mentioned at the outset, in which the actuating element is arranged completely inside the insulation material housing, wherein the conductor connection terminal has an auxiliary actuation element with an actuating section which is accessible at the outer side of the insulation material housing, and at which the auxiliary actuation element is manually actuatable, the auxiliary actuation element being configured to transfer to the actuating element a manual actuating movement, exerted on the actuating section, for bringing the clamping leg into the open position. This variant may also be advantageously combined with the above-mentioned examples of the conductor connection terminal.

This variant of the invention has the advantage that the actuating element, with a comparatively complex design, may be enclosed by the insulation material housing and thus protected, with only a comparatively small auxiliary actuation element having to be accessible at the outer side of the insulation material housing. The actuating section of the auxiliary actuation element may be configured for direct manual actuation, i.e., without a tool, or for actuation by a tool. This allows reliable manual actuation of the actuating element.

The auxiliary actuation element may be designed as a component that is separate from the actuating element. The auxiliary actuation element may also be formed in one piece with the actuating element. In an example, during manufacture the auxiliary actuation element may initially be formed in one piece with the actuating element, for example by connecting it to the actuating element via a thin material bridge. The thin material bridge may provide a predetermined breaking point that can be broken, for example, during installation of parts of the conductor connection terminal. The actuating element may thus be decoupled from the auxiliary actuation element; i.e., these parts are no longer directly coupled.

The object stated at the outset is further achieved by an electrical plug connector, in particular a circular plug connector, having at least one conductor connection terminal of the type described above. The above-mentioned advantages may also be achieved in this way.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a conductor connection terminal with a view of the conductor connection side,

FIG. 2 shows a busbar in a perspective view,

FIG. 3 shows a clamping spring in a perspective view,

FIG. 4 shows the busbar according to FIG. 2 together with the clamping spring according to FIG. 3,

FIG. 5 shows the arrangement according to FIG. 4 together with an actuating element,

FIG. 6 shows an actuating element in a three-sided view,

FIG. 7 shows the spring-loaded clamping connection according to FIG. 5 in a side view with the actuating element actuated,

FIG. 8 shows the spring-loaded clamping connection according to FIG. 7 in a lateral sectional view in the latched open position and with an insulation material housing,

FIG. 9 shows the spring-loaded clamping connection according to FIG. 8 in a section plane parallel to FIG. 8,

FIG. 10 shows a busbar in a perspective view,

FIG. 11 shows a spring-loaded clamping connection,

FIG. 12 shows an actuating element in a two-sided view,

FIG. 13 shows the spring-loaded clamping connection according to FIG. 11 in a lateral sectional view,

FIG. 14 shows the spring-loaded clamping connection according to FIG. 13 in a section plane parallel to FIG. 13,

FIG. 15 shows a busbar in a perspective view,
FIG. 16 shows an actuating element in a two-sided view,
FIG. 17 shows a spring-loaded clamping connection in the clamping position,
FIG. 18 shows the spring-loaded clamping connection according to FIG. 17 with the actuating element actuated, and

FIG. 19 shows the spring-loaded clamping connection according to FIG. 17 in the latched open position.

### DETAILED DESCRIPTION

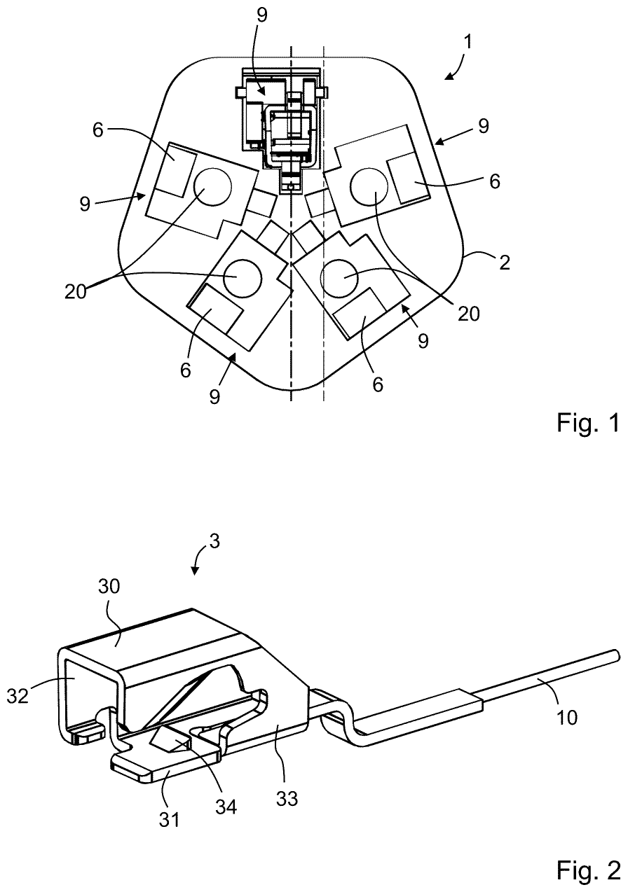

FIG. 1 shows an example of a conductor connection terminal 1 that has an insulation material housing 2. Multiple spring-loaded clamping connections 9 are accommodated in the insulation material housing 2. In the illustrated example, the spring-loaded clamping connections 9 are arranged along a ring-shaped track around a center in the insulation material housing 2, for example on a circular path. However, the invention further relates to conductor connection terminals with different types of housing designs and different arrangements of spring-loaded clamping connections, for example spring-loaded clamping connections arranged next to one another in a row.

FIG. 1 shows the conductor connection terminal 1 with a view of a conductor insertion side, in which the insulation material housing 2 has a conductor insertion opening 20 for each spring-loaded clamping connection 9. An electrical conductor may be inserted through the conductor insertion opening 20 and into the insulation material housing 2 and connected to the spring-loaded clamping connection 9. As an example, in FIG. 1 one of the spring-loaded clamping connections 9 is illustrated without the housing cover. Each spring-loaded clamping connection 9 also has a manual actuating element 6, e.g. actuator, that is designed as a displaceable actuating element in the form of a push button or actuating slider.

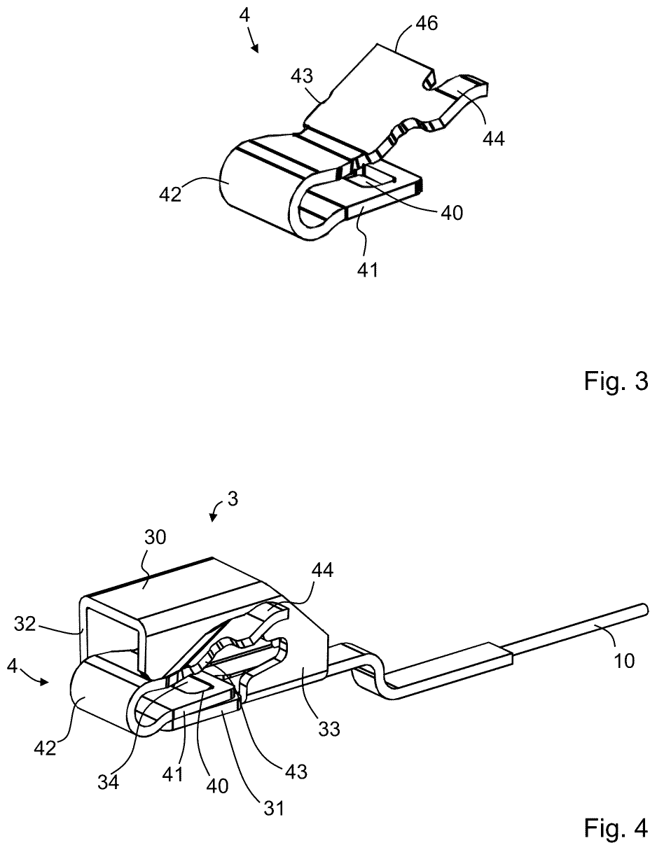

Each spring-loaded clamping connection 9 also has a busbar 3 as illustrated in FIG. 2, for example, and a clamping spring 4 as illustrated in FIG. 3, for example. The busbar 3 has a contact section 30 to which an electrical conductor may be connected. The busbar 3 also has a spring retainer section 31 opposite from the contact section 30, for example essentially parallel thereto, at which, for example, a retaining element 34 for retaining the clamping spring 4 may be arranged. The contact section 30 may be connected to the spring retainer section 31 via one or two connecting walls 32, 33. The connecting walls 32, 33 may be designed, for example, as side walls of an area of the busbar 3 having an overall frame-like design. The busbar 3 thus forms a contact frame into which the clamping spring 4 may be inserted.

The conductor connection terminal 1 may be designed as an electrical plug connector, for example. The busbar 3 may then be connected to a plug connection 10 of the plug connector or formed in one piece therewith.

The clamping spring 4 has a contact leg 41, a spring bend 42 adjoining the contact leg 41, and a clamping leg 43 adjoining the spring bend 42. At an end facing away from the spring bend 42, the clamping leg 43 has a clamping edge 46 that is used to connect the electrical conductor to the contact section 30. An actuating section 44, for example in the form of an actuation tab, branches off from the clamping leg 43 at least on one side. The actuating section 44 is used for actuation of the clamping leg 43 by the actuating element 6, as explained in greater detail below. A fastening element 40 is formed at the contact leg 41, for example with an opening extending through the contact leg 41 via which the contact leg 41 may be fastened to the retaining element 34, as illustrated in FIG. 4.

FIG. 4 shows the clamping spring 4 mounted in the contact frame of the busbar 3. The clamping spring 4 now rests with its contact leg 41 on the spring retainer section 31, and thus supports the clamping spring 4 against the force of the clamping leg 43. It is apparent that the actuating section 44 extends laterally from the connecting wall 33. An appropriate opening may be formed in the connecting wall 33 for this purpose.

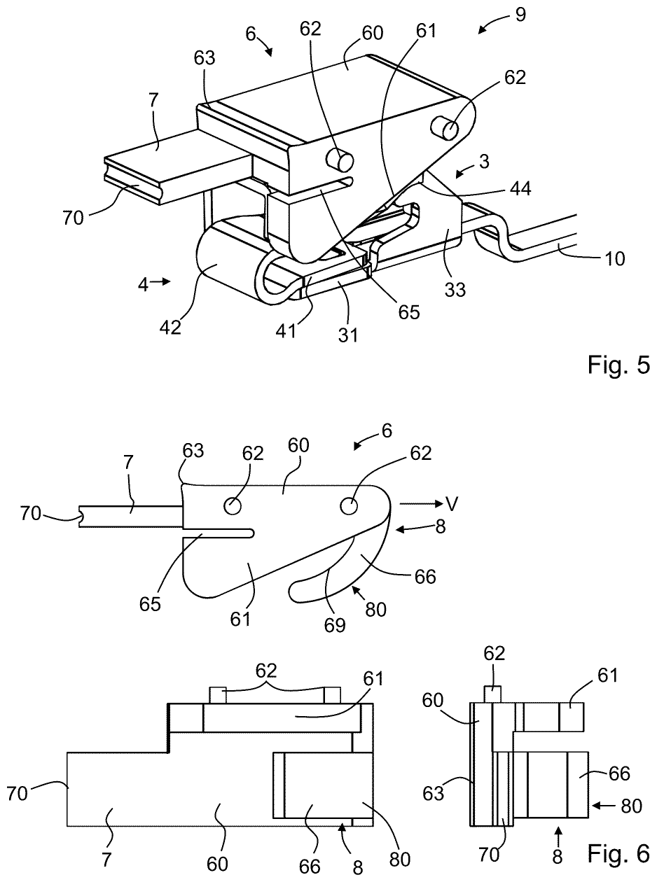

FIG. 5 shows a spring-loaded clamping connection 9 having the arrangement made up of the busbar 3 and the clamping spring 4 according to FIG. 4. In addition, an actuating element 6 is present. The actuating element 6 is also illustrated from three different viewing directions in FIG. 6.

The actuating element 6 has a main body 60 at which guide pins 62, which protrude laterally at one longitudinal side or at both opposite longitudinal sides, are arranged. The main body 60 also has at least one spring action section 61, for example with an actuating surface which extends obliquely with respect to the displacement direction V of the actuating element 6, and which deflects the actuating section 44 of the clamping spring 4 during the displacement movement of the actuating element 6. A first detent element 63 is arranged at the main body 60. A guide slot 65 is also formed on the main body 60. The actuating element 6 also has an auxiliary actuation element 7 that is formed in one piece with the main body 60 and that protrudes therefrom as an elongated section, opposite the displacement direction V. A manual actuating section 70 that is configured for applying the manual actuating force is arranged at the auxiliary actuation element 7.

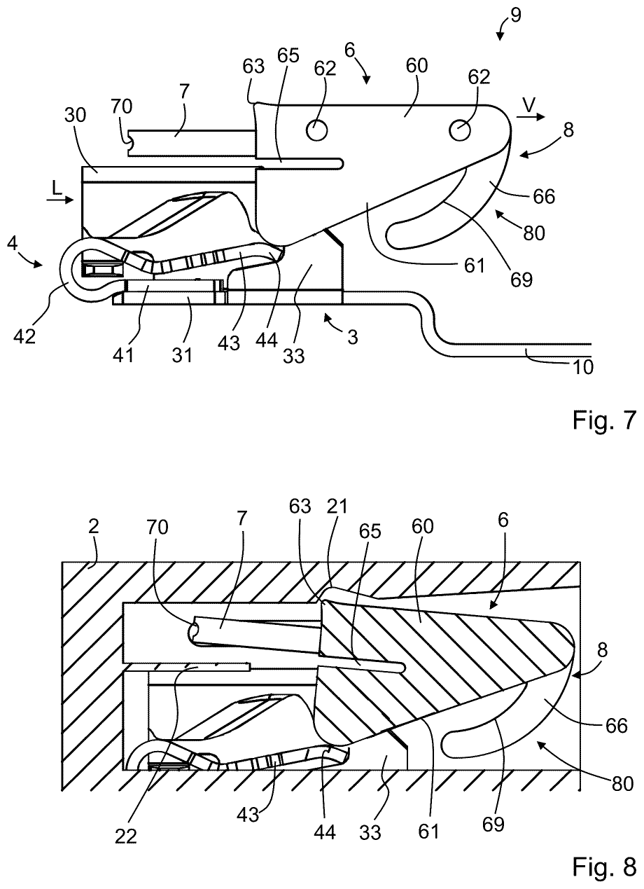

The spring-loaded clamping connection 9 also has a release element 8 with a release section 80. The release element 8 is used to release latching of the actuating element 6 in the open position, in that an inserted electrical conductor exerts a release force on the release section 80. In the illustrated example, the release element 8 together with the release section 80 is designed as a curved arm 66 that protrudes from the main body 60. As a result of the curved shape, the release section 80 thus formed has an area 69 that is arranged at an oblique angle with respect to the conductor insertion direction L (as is apparent in FIG. 7).

FIG. 5 illustrates the spring-loaded clamping connection 9 for an unactuated actuating element 6; i.e., the actuating element 6 is in a starting position, and the clamping leg is in the clamping position. FIG. 7 shows the spring-loaded clamping connection 9 with the actuating element actuated. The actuating element 6 has now been pushed away from the starting position in the displacement direction V. The clamping leg 43 has been deflected in the direction of the open position by means of the spring action section 61. When a certain position is reached during this displacement movement, as illustrated in FIG. 8, the actuating element 6, which thus far has moved linearly in the displacement direction V, may additionally carry out a swivel movement or tilting movement. Due to this swivel or tilting movement, the first detent element 63 comes into engagement with a second detent element 21, which may be arranged at the insulation material housing 2, for example. The actuating element 6 is thus latched in the open position, and accordingly cannot be moved by the clamping leg 43 in the direction of the starting position. This swivel movement of the actuating element 6 may be achieved, or at least assisted, by the elastic force of the clamping spring 4 that acts by the clamping leg 43 on the actuating element 6. Due to the force of the clamping spring 4, secure latching between the first detent element 63 and the second detent element 21 is thus ensured.

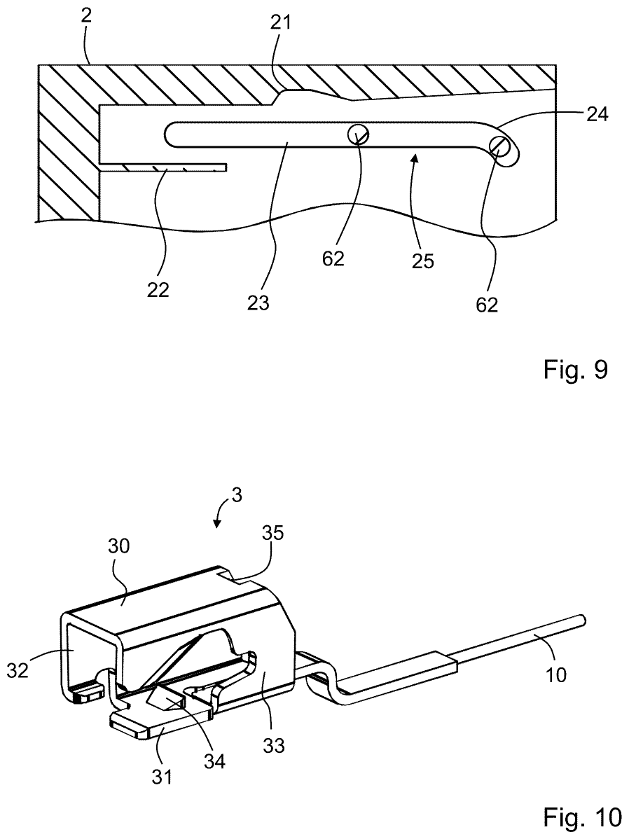

FIG. 9 shows how the guide pins 62 are guided in a guide groove 25 of the insulation material housing 2. FIG. 9 shows the same actuation state as FIG. 8; i.e., the actuating element 6 has already been swiveled. It is apparent that the predominant portion of the guide groove 25 is formed as a linearly extending section 23 that runs parallel to the conductor insertion direction L. The guide groove 25 has a curved section 24 toward the rear end in the direction of the open position. As a result of this curved section 24, the actuating element 6 is additionally guided over the guide pins 62 during the swivel movement; i.e., the curved section 24 likewise brings about a swivel movement of the actuating element 6.

As also illustrated in FIGS. 8 and 9, a guide wall 22 may be formed at the insulation material housing 2. The guide wall 22 may cooperate with the guide slot 65, at least in the area of the starting position of the actuating element 6, to bring about additional guiding of the actuating element 6. That is, in the area of the starting position the guide wall 22 may immerge into the guide slot 65.

If the latched position of the actuating element 6 illustrated in FIG. 8 is to be discontinued once again, this may take place by inserting an electrical conductor in the conductor insertion direction L. When the end of the electrical conductor strikes the area 69 of the release element 80, which is inclined relative to the conductor insertion direction L, the electrical conductor 9 is thus deflected upwardly in the direction of the contact section 30, and in particular may run up against the main body 60 of the actuating element 6. At the same time, a swivel torque is thus generated by the electrical conductor 9 which brings about a swivel movement of the actuating element 6, as a result of which the latching of the actuating element 6 is released. The actuating element 6 is thus brought once again into the unswiveled position illustrated in FIG. 7. In this position, the actuating element 6 may be moved back by the clamping leg 43 or directly by the actuating section 44 in the direction of the starting position.

FIG. 10 shows an example of a busbar 3 that largely corresponds to the example according to FIG. 2. In contrast to FIG. 2, here a second detent element 35 is formed at the busbar 3.

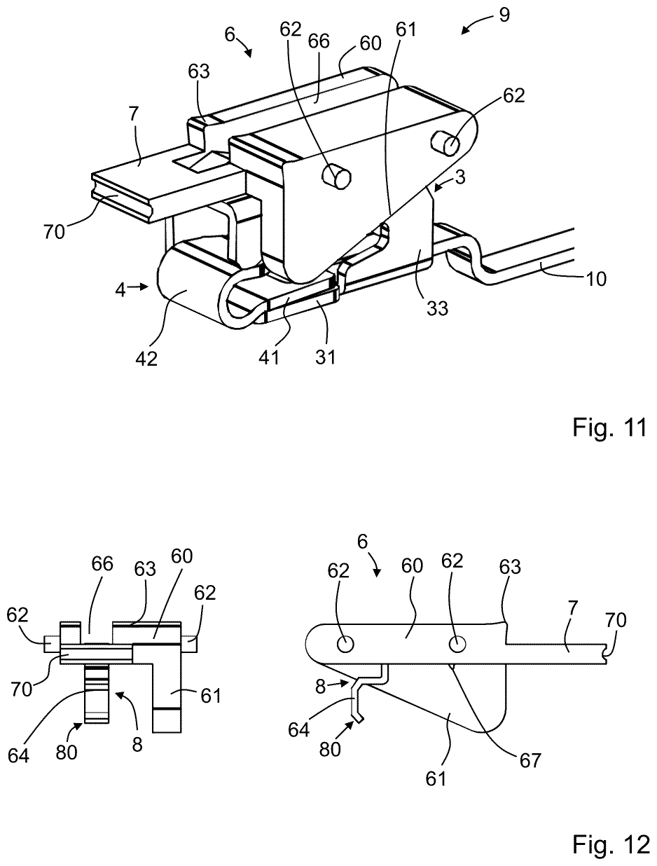

FIG. 11 shows a spring-loaded clamping connection 9 in which a busbar 3 according to FIG. 10 and a clamping spring 4 according to FIG. 3 are present. Also present is an actuating element 6, which except for the differences explained below may correspond to an actuating element 6 according to FIG. 6.

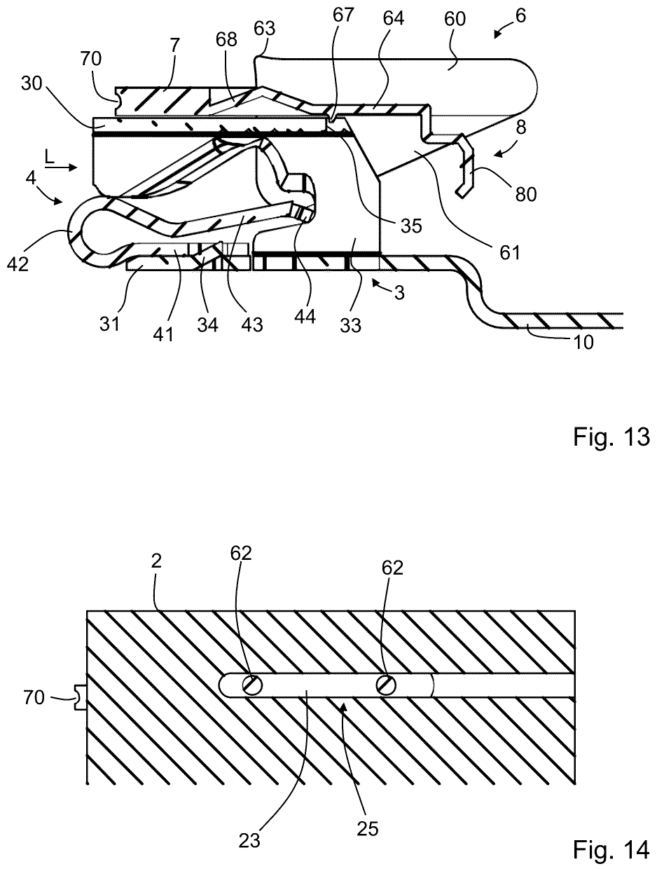

The actuating element 6 in the example in FIG. 11 is additionally illustrated in FIG. 12 in various views. It is apparent, for example, that in this example the guide pins 62 may be present on both longitudinal sides of the main body 60, i.e., may project from the main body 60 on both sides in opposite directions. A release element 8 with a release section 80 is once again present, which in this case is designed as an elastically deflectable detent arm 64. The detent arm 64 may be formed in one piece with the main body 60 or may be joined thereto in some other way. The detent arm 64 has the release element 8 with the release section 80 in the area of the free end of the detent arm. An additional first detent element 67 is present for latching the actuating element 6 in the open position, as is additionally apparent in FIG. 13. The additional first detent element 67 is likewise arranged at a position on the detent arm 64.

FIG. 13 shows the spring-loaded clamping connection 9 with the actuating element 6 actuated, wherein the clamping leg 43 is already transferred into the open position and the actuating element 6 is latched. In this case the latching takes place by latching the additional first detent element 67 to the second detent element 35 at the busbar 3. It is apparent that the detent arm 64, starting from its connection point to the main body 60 or to the auxiliary actuation element 7 via a multiply angled or meandering area 68, extends toward the additional first detent element 67, and from there extends to the release section 80 via multiple bends. The release section 80 extends essentially orthogonally with respect to the conductor insertion direction L. When an electrical conductor is inserted in the conductor insertion direction L and exerts a release force on the release section 80, as a result of the elastic property of the detent arm 64 the detent arm 64 is deflected, so that the additional first detent element 67 releases from the second detent element 35. By means of the area 68, in particular a desired elasticity of the detent arm 64 may be provided in the desired manner.

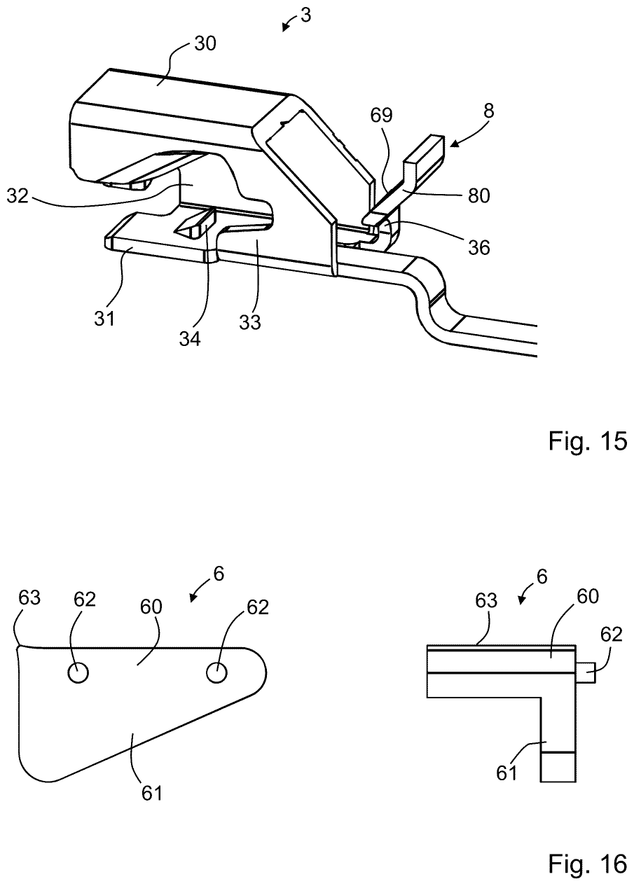

FIG. 14 shows the guiding of the guide pins 62 of the actuating element 6 in the guide groove 25, using the example of the spring-loaded clamping connection 9 according to FIG. 13. In this case the guide groove 25 is formed only with the linearly extending section 23.

FIG. 15 shows an example of a busbar 3, which except for the differences explained below may correspond to the example according to FIG. 2. In contrast to FIG. 2, the busbar according to FIG. 15 has a release element 8 with the release section 80. The release element 8 may be connected to a portion of the busbar 3, for example the spring retainer section 31, via a connecting arm 36, or may be formed in one piece therewith. The release section 80, similarly to the example according to FIG. 6, once again has an area 69 that is inclined relative to the conductor insertion direction L, for example a ramp-like area, via which the inserted electrical conductor is deflected in the direction of the contact section 30. A clamping spring 4 according to FIG. 3 may once again be fastened to the busbar 3. The release element 8 here is essentially rigid with an immovable design, although it would be advantageous and also possible to utilize the connecting arm 36 as a flexible connection to the release element 8 so that the release element may have a movable design. In the illustrated design, the sole function of the release section 80 is to provide a change of direction for the inserted conductor due to the inclination 69. Due to this change of direction, the conductor strikes the latched actuating element, which in turn is more favorable for the rocker situation.

FIG. 16 shows an example of an actuating element 6, which except for the differences explained below may be designed like the example according to FIG. 6. In contrast to the example in FIG. 6, the example according to FIG. 16 has no auxiliary actuation element 7 that is integrally formed on the main body 60. In addition, there is also no release element 8 with a release section 80 at the main body 60. The guide slot 65 illustrated in FIG. 6 is not depicted in the illustrations; however, the example according to FIG. 16 may also have the guide slot 65.

FIG. 17 shows a spring-loaded clamping connection 9 with the actuating element 6 explained with reference to FIG. 16 and the busbar 3 according to FIG. 15. In addition, an auxiliary actuation element 7 of the type explained above is present. However, this auxiliary actuation element is not part of the actuating element 6, but instead is a separate component used to transfer the actuating force of the manual actuation at the actuating section 70 to the actuating element 6. FIG. 17 shows the spring-loaded clamping connection 9 in the starting position of the actuating element 6, and accordingly, in the clamping position of the clamping leg 43.

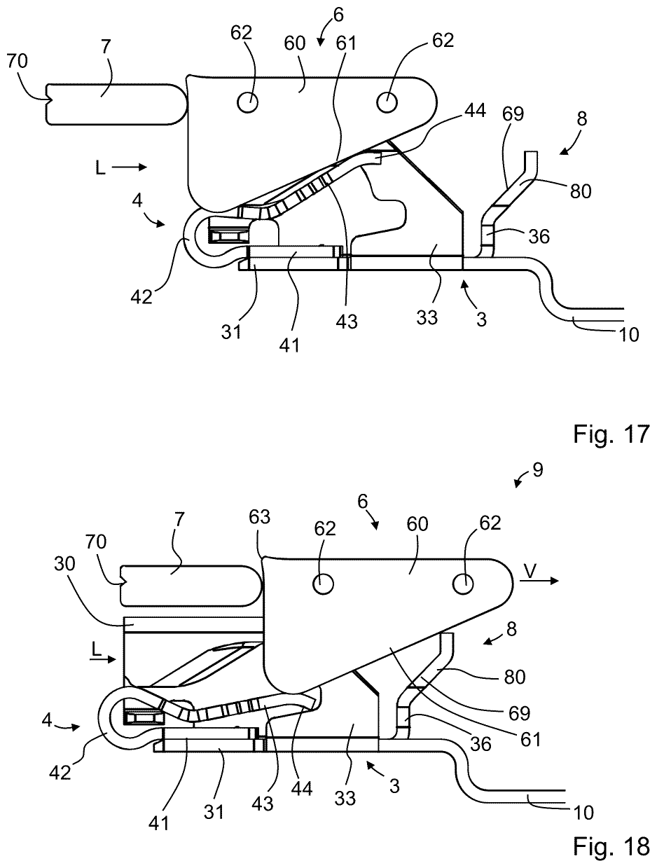

FIG. 18 shows the spring-loaded clamping connection 9 according to FIG. 17 after the actuating element 6 is actuated; i.e., the actuating element 6 has been moved in the displacement direction V, and the clamping leg 43 has been correspondingly deflected in the direction of the open position. The actuating element 6 is not yet in the latched position.

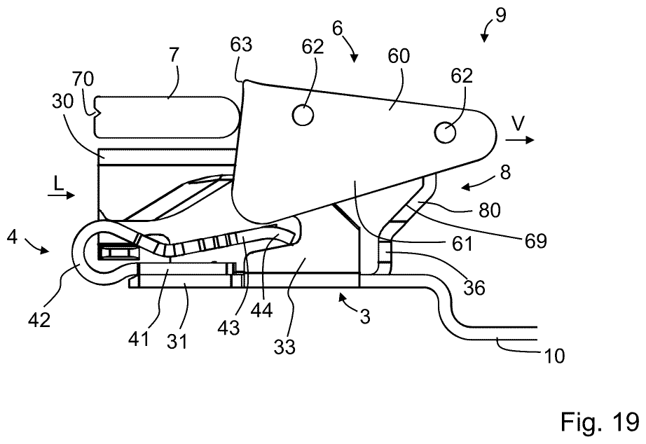

FIG. 19 shows the spring-loaded clamping connection 9 after the actuating element 6 has been transferred into the latched position. The clamping leg 43 is now held in the open position by the actuating element 6. The latching takes place in the same way, via the first detent element 63 in combination with the second detent element 21, as explained with reference to FIGS. 8 and 9.

When an electrical conductor is inserted in the conductor insertion direction L and pressed against the release section 80, as a result the release section 80 is at least essentially undeflected. Instead, due to the inclined area 69 the release section 80 has the function of diverting the inserted electrical conductor upwardly with respect to the conductor insertion direction L, i.e., in the direction of the contact section 30. The electrical conductor thus comes into contact with the main body 60 of the actuating element 6, causing the actuating element 6 to carry out an opposite swivel movement which releases the latching between the first detent element 63 and the second detent element 21. As a result, the actuating element 6 is moved once again in the direction of the starting position via the clamping leg 43, whereby the clamping leg 43 rebounds and is able to clamp the electrical conductor to the contact section 30.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor connection terminal comprising:
an insulation material housing; and
at least one spring-loaded clamping connection arranged in the insulation material housing to connect an electrical conductor via an elastic force, the spring-loaded clamping connection having at least one busbar and at least one clamping spring having a clamping leg to clamp the electrical conductor to at least one contact section of the busbar,
wherein the insulation material housing has at least one conductor insertion opening through which an electrical conductor is guidable in a conductor insertion direction to a clamping point formed by the clamping leg and the contact section of the busbar,
wherein the conductor connection terminal has a manual actuator in the form of a displaceable push button or actuating slider via which by manual actuation, the clamping leg is adapted to be moved into an open position via a displacement movement of the actuator relative to the insulation material housing,
wherein upon reaching the open position, the actuator is latchable to at least one component of the conductor connection terminal,
wherein, in the latched position of the actuator, the clamping leg is held in the open position by the actuator, and
wherein the actuator, at least during the displacement movement, is guided via at least one guide pin that is guided in a guide groove that extends at least predominantly in the displacement direction of the actuator.

2. The conductor connection terminal according to claim 1, wherein at least the predominant portion of the guide groove extends in a straight line or in parallel to the conductor insertion direction.

3. The conductor connection terminal according to claim 1, wherein upon reaching the open position, the actuator is latchable to at least one component of the conductor connection termina via a swivel movement.

4. The conductor connection terminal according to claim 3, wherein the guide groove in the area of the open position has at least one protrusion and/or a curved section via which the actuator is guided during the swivel movement.

5. The conductor connection terminal according to claim 3, wherein the swivel movement of the actuator in the open position may be partially, predominantly, or completely carried out by a reaction force of the clamping spring that acts by the clamping leg on the actuator.

6. The conductor connection terminal according to claim 1, wherein the actuator has a first detent via which the actuator in the open position is latchable to a second detent of another component of the conductor connection terminal or to the busbar or to the insulation material housing.

7. The conductor connection terminal according to claim 1, wherein the conductor connection terminal has a release with a release section, via which the latching of the actuator in the open position is releasable and the clamping leg is automatically movable from the open position in the direction of the clamping position when the release section is acted on with a release force by the inserted electrical conductor.

8. The conductor connection terminal according to claim 7, wherein the release is arranged at the actuator, at the busbar, or at the clamping spring, and is formed in one piece with the actuator, with the busbar, or with the clamping spring.

9. The conductor connection terminal according to claim 7, wherein the release section has at least one area, arranged obliquely with respect to the conductor insertion direction, via which the electrical conductor is deflected toward the contact section during the insertion operation.

10. The conductor connection terminal according to claim 1, wherein at least one elastically deflectable detent arm is arranged at the actuator or is formed in one piece with the actuator, and wherein the detent arm has a first detent for latching the actuator in the open position.

11. The conductor connection terminal according to claim 10, wherein the detent arm is deflectable by actuating the release section in order to release the latching of the actuator in the open position.

12. The conductor connection terminal according to claim 10, wherein the release is arranged at the detent arm, and is formed in one piece with the detent arm.

13. A conductor connection terminal comprising:
an insulation material housing; and
at least one spring-loaded clamping connection arranged in the insulation material housing to connect an electrical conductor via an elastic force, the spring-loaded clamping connection having at least one busbar and at least one clamping spring having a clamping leg for clamping the electrical conductor to at least one contact section of the busbar,
wherein the insulation material housing has at least one conductor insertion opening through which an electrical conductor is guidable in a conductor insertion direction to a clamping point formed by the clamping leg and the contact section of the busbar,
wherein the conductor connection terminal has a manual actuator in the form of a displaceable push button or actuating slider via which by manual actuation the clamping leg is adapted to be moved into an open position via a displacement movement of the actuator relative to the insulation material housing,
wherein, upon reaching the open position, the actuator is latchable to at least one component of the conductor connection terminal,
wherein in the latched position of the actuator the clamping leg is held in the open position by the actuator,
wherein the actuator is arranged completely inside the insulation material housing,
wherein the conductor connection terminal has an auxiliary actuator with an actuating section which is accessible at an outer side of the insulation material housing, and at which the auxiliary actuator is manually actuatable, the auxiliary actuator being configured to transfer to the actuator a manual actuating movement, exerted on the actuating section, to bring the clamping leg into the open position.

14. The conductor connection terminal according to claim 13, wherein the auxiliary actuator is designed as a component that is separate from the actuator.

15. The conductor connection terminal according to claim 13, wherein the spring-loaded clamping connections are arranged along a ring-shaped track around a center in the insulation material housing.

16. The conductor connection terminal according to claim 13, wherein at a conductor insertion side the conductor connection terminal has conductor insertion openings through which electrical conductors can be guided to the clamping points, wherein at an insertion face side facing away from the conductor insertion side the conductor connection terminal has plug openings that lead to electrical plug contacts arranged in the insulation material housing of the conductor connection terminal.

17. An electrical plug connector, or a circular plug connector, comprising at least one conductor connection terminal according to claim 1.
